(19) United States
(12) Patent Application Publication
(10) Pub. No.: US 2004/0211397 A1
(43) Pub. Date: Oct. 28, 2004

(54) Fuel diffuser for combustion

(76) Inventor: Russell Metum Laustsen, New Bern, NC (US)

Correspondence Address: Russell M. Laustsen, 5201 Moye Road, New Bern, NC, 28562, US

(21) Appl. No.: 10/724,462

(22) Filed: Dec. 1, 2003

Related U.S. Application Data
(60) Provisional application No. 60/429,903, filed on Dec. 2, 2002.

(51) Int. Cl. F02M 27/00

(52) U.S. Cl. 123/538

(57) ABSTRACT

This invention uses the electrical system of the vehicle as a catalyst to improve the rate of combustion of hydrocarbon fuels.

The result of using the device is that less energy is used and the exhaust emissions are reduced for a given workload. The device is installed in the fuel line leading to the combustion system.

### CROSS-REFERENCE TO RELATED APPLICATIONS

Provisional application number 60/429,903

### STATEMENT REGARDING FEDERALLY SPONSORED RESEARCH OR DEVELOPMENT

Not Applicable

### BACKGROUND OF THE INVENTION

This invention relates to improving the fuel consumption on engines and boilers in use by domestic commercial and industrial applications. When you improve the combustion of fuel, the result is less harmful emissions from the exhaust.

Our society is more dependent on hydrocarbon fuels used in transportation, heating and power generation than ever before. The present population uses even more vehicles and combustion burning appliances, thus increasing air pollution.

Also, many vehicles manufacturers have ignored the fuel efficiency of the engines to promote more power, speed and conveniences in their designs.

Because of these factors, this invention design is adapted to be installed on existing systems to improve combustion and reduce pollution.

### SUMMARY OF THE INVENTION

This invention provides a means to use the existing electrical system to increase the combustion efficiency of the engine. The device uses the direct current voltage of the vehicles system to create a magnetic circuit in the pipe chamber as the fuel flows through the vessel.

The flowing fuel is directed at approximately right angles to the magnetic field by the helical coil within the pipe.

The result is that an electrical charge is created in the fuel particles before it enters the combustion chamber. When the fuel is flashed into fine particles in the combustion chamber, the like charged fuel particles separate. This separation allows more combustion air to diffuse with the charged particles for more complete combustion and therefore saving fuel and having a cleaner exhaust.

### BRIEF DESCRIPTION OF THE DRAWINGS

The invention is illustrated but not limited by the attached drawings.

FIG. 1 is an external view of this invention.

FIG. 2 is an internal view of FIG. 1 with the outer housing sectioned to show the internal elements of the device.

FIG. 3 is a view of electrode 13 with insulated copper coil wound on its outside diameter.

### DETAILED DESCRIPTION OF THE INVENTION

This invention is for the treatment of hydrocarbon or fossil fuels to improve the combustion of the fuel which is used in a combustion chamber [not illustrated].

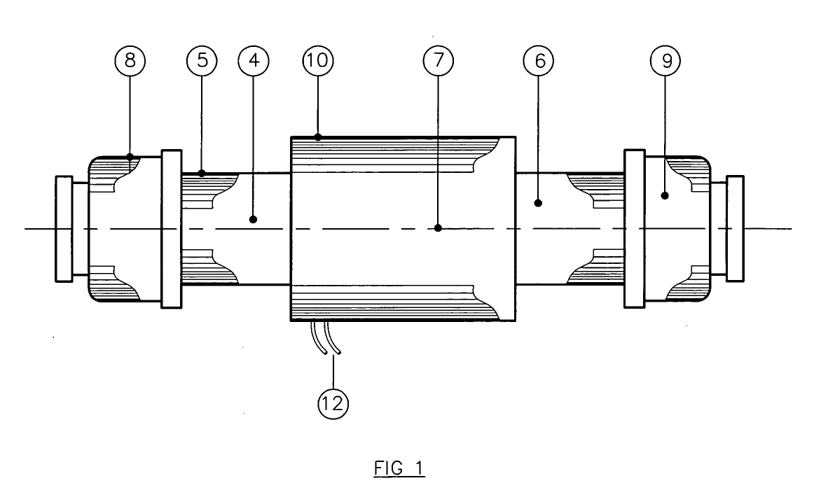

In FIG. 1, component 4 is a hollow metal tube with 5 indicating the wall. The surface is shown by 6 and the longitudinal axis is 7. The inlet end connection of the device 8 receives the fuel to be treated. At the opposite end, the outlet connection of the device 9 is provided for dispensing fuel to a combustion chamber.

FIG. 3 shows a graphite rod electrode 13 wound with a fine insulated copper wire 14A spaced one diameter apart. The ends of the inner coil 14A and electrode are connected together on each end.

This electrode assembly FIG. 3 is again wound with a larger insulated copper wire 14 forming a helical coil. The coils 14 are spaced one diameter apart.

The completed assembly FIGS. 3 and 14 is placed within the pipe 5. This outer coil 14 and electrode assembly FIG. 3 forms a passageway between the electrode assembly FIG. 3 and the inner pipe wall 5A to allow for free flowing fuel 15.

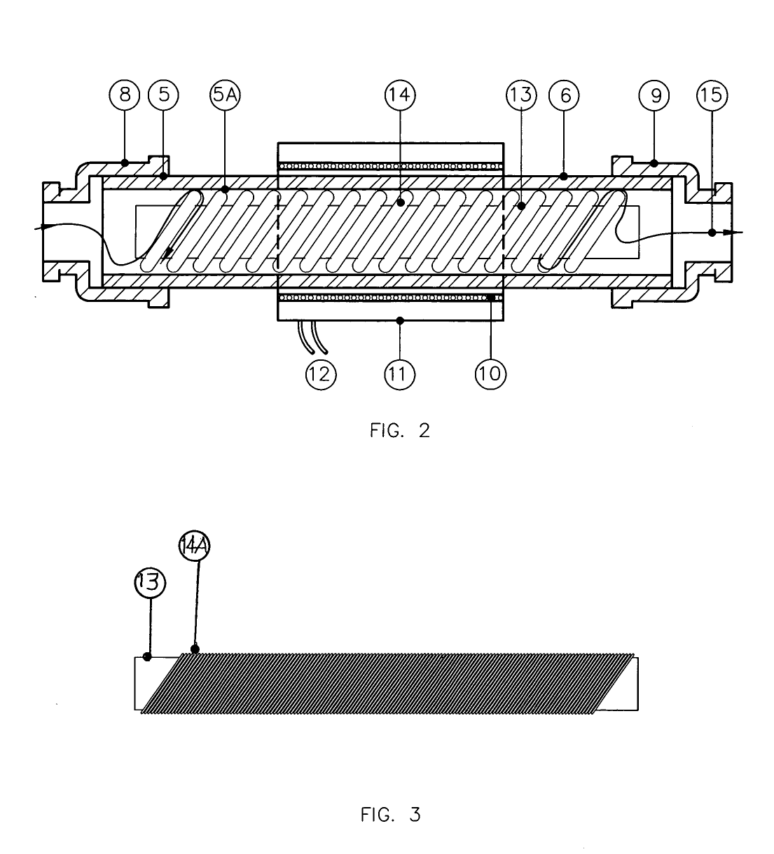

FIG. 2 shows coil 10 located outside pipe 4. When coil 10 is energized with a direct current voltage supply connected to leads 12, a magnetic circuit is created. The magnetic flux of the magnetic circuit flows along the iron pipe surface 5 through the centerline of the pipe 7, electrode 13 and coils 14 and 14A.

The space between the helical coil 14 and pipe wall 5A guides the fuel 15 at approximately right angles to the lines of magnetic flux and across coil winding 14A. This fuel 15 [movement] generates an electromotive force or electrical charge within the electrode assembly 13. The current generated flows from the electrode assembly 13 to the negative iron pipe wall 5A. This results in the charging of the fuel particles 15 as it flows through the helical coil passageway. This electrical charged fuel 15 flows from the outlet 9 through the fuel line to injectors or nozzles to dispense it to the combustion chamber [not shown].

The like charged fuel particles repel each other diffusing with the air provided for combustion. The better mix results in more complete combustion.

Other factors due to better combustion are:

Less pollution due to less fuel loss

Reduce cost of fuel

Cleaner internal engine surfaces

What I claim as my invention is:

1. A means of using the power source of a vehicle or an inexpensive direct current power source to create a magnetic circuit within the fuel diffuser pipe to generate a charge in the flowing fuel which in turn diffuses with the air for better combustion in the chamber.

2. The fuel path across the magnetic flux by the helical coil increases its exposure of fuel to the magnetic flux and creates more efficient electrical charges for diffusion with the combustion air.
